(19) United States
(12) Patent Application Publication
(10) Pub. No.: US 2025/0052144 A1
(43) Pub. Date: Feb. 13, 2025

(54) Method of Calculating Wellhead System Load Capacity

(71) Applicant: Plexus Holdings PLC, Aberdeen (GB)

(72) Inventors: Craig Hendrie, Aberdeen (GB); Brent Harrald, Aberdeen (GB)

(21) Appl. No.: 18/719,785

(22) PCT Filed: Dec. 15, 2022
(86) PCT No.: PCT/GB2022/053246

§ 371 Date: Jun. 13, 2024

(30) Foreign Application Priority Data
Dec. 16, 2021 (GB) 2118327.2

(51) Int. Cl. E21B 47/007; E21B 33/03

(52) U.S. Cl. CPC E21B 47/007; E21B 33/03

(57) ABSTRACT

The present invention provides a method of calculating the load capacity of a wellhead system. The method comprises determining a first contact stress at a first interface between an annular component and a collar and equating a radial deflection of an inner surface of the annular component with a radial deflection of an outer surface of the collar. The method uses a first contact stress and the axial movement of the annular component to determine a contact stress at a gripping interface between a gripping surface and an inner tubular member. The method also equates a radial deflection of the outer surface of the inner tubular member with (i) a radial deflection of the gripping surface plus (ii) a depth of penetration of a ridge of the outer surface of the inner tubular member into the gripping surface (iii) a radial dimension of an initial gap between the outer surface of the inner tubular member and the inner surface of the outer tubular member.

### FIELD OF THE INVENTION

The present invention relates to a method of calculating the load capacity of a wellhead system.

### BACKGROUND TO THE INVENTION

In wellhead systems it is often necessary to support the load of an inner tubular member that is disposed within an outer tubular member. In particular, in oil and gas wells, it is conventional to locate a number of concentric tubes or casings in a well. An outmost casing is held in a fixed position, and a plurality of inner casings are disposed through and within the outer casing. Each inner casing is supported by a respective hanger.

Traditionally the inner casings are supported using casing hangers which may include inter-engaging shoulders on the inner and outer casing. Such casing hangers are fixed in position on each casing. Systems which make it easy, simple and reliable to land and connect the hangers for the casings are very desirable. Furthermore, in some situations, it can be advantageous to be able to adjust the position of one casing relative to another casing.

It is known to provide a clamping system that permits an inner casing to be clamped in a desired position within an outer casing, and then to subsequently unclamp the casings. These systems are reliable and simple and allow the hanger for the casing to be landed and connected. Such a system may also allow for a change in their relative positions and then re-clamp the casings in a new relative position. In these systems an inner casing or tubing hanger is supported by applying a generally radial force to an outer member or the outer casing to elastically squeeze the outer member/casing around the inner casing or hanger. Friction at this interface then supports the inner casing.

In these systems a reliable seal is provided around the inner casing/hanger and, in addition, the inner casing is locked down and upwards movement of the inner casing is prevented. Accordingly, such systems releasably secure the hanger in place and allow the hanger to be released and removed and/or to be secured/unsecured for whatever reason.

These clamping systems are friction grip wellhead systems which use and rely on the frictional grip to secure components in the bore of concentric casings/tubular members.

The load capacity of the clamping system is therefore a function of the contact stress at the interface between the casings. In a large wellhead system, however, the surfaces at the interface between the inner casing and the outer casing are not ideal smooth surfaces. Additionally, manufacturing tolerances and gaps between components of the clamping system and between inner and outer casings must be considered when determining contact stresses and therefore overall load capacity of the clamping system.

Against this background it is desirable to provide a method of calculating the load capacity of a wellhead system.

It is an aim of the present invention to overcome at least one problem associated with the prior art whether referred to herein or otherwise.

### SUMMARY OF THE INVENTION

According to a first aspect of the present invention there is provided a method of calculating the load capacity of a wellhead system, the wellhead system comprising a clamping arrangement comprising a collar having an externally tapered surface, the arrangement also including an annular component with an internally tapered surface, the collar and the annular component being relatively axially moveable between a first position in which the tapered surface of the annular component exerts no radial force on the collar and a second position in which the tapered surface of the annular component exerts sufficient radial force to distort the collar inwardly in order to grip an inner tubular member within a gripping surface and to support a load of the inner tubular member, the inner tubular member having an outer surface including a ridged profile, and the method comprising:
determining a first contact stress at a first interface between the annular component and the collar, by equating a radial deflection of an inner surface of the annular component with a radial deflection of an outer surface of the collar;
using the first contact stress and the axial movement of the annular component to determine a contact stress at a gripping interface between the gripping surface and the inner tubular member, by equating a radial deflection of the outer surface of the inner tubular member with (i) a radial deflection of the gripping surface plus (ii) a depth of penetration of a ridge of the outer surface of the inner tubular member into the gripping surface (iii) a radial dimension of an initial gap between the outer surface of the inner tubular member and the inner surface of the outer tubular member.

The method may comprise manufacturing a wellhead. The method may comprise manufacturing the collar and the annular component.

The method may comprises selecting a material and/or dimensions for the collar and/or the annular component based on parameters derived from the method in accordance with the first aspect.

The gripping surface may be provided on an inner surface of the collar. The gripping interface may be formed between the inner surface of the collar and the outer surface of the inner tubular member.

The gripping surface may be provided on an inner surface of an outer tubular member. The outer tubular member may be located between the outer surface of the inner tubular member and the inner surface of the collar. The gripping interface may be formed between the inner surface of the outer tubular member and the outer surface of the inner tubular member.

Preferably the inner tubular member is arranged to be suspended from the gripping surface and for the inner tubular member to extend downwardly within an outer tubular member.

The method may comprise determining a second contact stress at a second interface between the collar and the outer tubular member assuming negligible hoop stiffness of the collar.

The method may comprise using the first contact stress, the second contact stress and the axial movement of the annular component to determine a contact stress at the gripping interface (a third interface) between the outer tubular member and the inner tubular member

Preferably step (i) comprises equating the radial deflection of the outer surface of the inner tubular member with a radial deflection of an inner surface (the gripping surface) of the outer tubular member.

Preferably step (ii) comprises equating the radial deflection of the outer surface of the inner tubular member with the depth of penetration of a ridge of the outer surface of the inner tubular member into the gripping surface comprising an inner surface of the outer tubular member.

Preferably step (iii) comprises equating the radial deflection of the outer surface of the inner tubular member with the radial dimension of the initial gap between the outer surface of the inner tubular member and the gripping surface comprising an inner surface of the outer tubular member.

Preferably the method comprises calculating the contact stress at the first (outer) interface and subsequently calculating the contact stress at the gripping (third/inner) interface.

Preferably the method comprises calculating the contact stress at the first (outer) interface and the contact stress at the second (intermediate) interface and subsequently calculating the contact stress at the gripping (third/inner) interface.

Preferably the method comprises adjusting the contact stresses at the first interface (and/or the second interface) to provide a gripping (third) contact stress which is equal to or greater than a desired contact stress at the gripping (third) interface.

Preferably the method comprises adjusting the desired contact stress based on a given load scenario. Preferably the method comprises adjusting the desired contact stress based on a given load scenario together with a safety factor.

Preferably the rated load capacity of the clamping system is given by:

$$RL = ( Q \times ϕ \times A\_s ) / SF$$

where,
Q is the contact stress at the gripping (third) interface,
ϕ is the grip coefficient at the gripping (third) interface,
As is the surface area at the gripping (third) interface, and
SF is a safety factor with respect to the minimum load capable of causing slip between the inner tubular member and the gripping surface which may be provided by an outer tubular member or by the collar.

Preferably the method comprises determining the grip coefficient (ϕ) as a ratio of a minimum axial load (Fs) capable of causing slip at the gripping interface to a radial force (Fn) applied to the gripping interface. Preferably the axial load (Fs) is applied in a direction generally parallel to the gripping interface and the radial force (Fn) is applied in a direction generally perpendicular to the gripping interface.

The grip coefficient may be determined empirically or by experimentation, or may be calculated by any known method. Preferably the grip coefficient is determined experimentally to take into consideration complex factors affecting the grip coefficient in a clamping system, for example variability in coefficients of friction over the areas of the gripping surfaces and the effect of a toothed surface biting into a mating surface.

Preferably the collar and the annular component are relatively axially moveable between a first position in which the tapered surface of the annular component exerts no radial force on the collar and a second position in which the tapered surface of the annular component exerts sufficient radial force to distort the collar inwardly in order to grip an inner tubular member to support a load of the inner tubular member and for the inner tubular member to extend within an outer tubular member.

The annular component may comprise an activating spool.

Preferably the annular component comprises a compression ring. The compression ring may comprise a first compression ring and a second compression ring.

Preferably the collar comprises a compression collar.

The compression collar may have an axially extending groove provided on the outer periphery and preferably the compression collar has a plurality of axially extending grooves provided radially around the outer periphery.

Preferably the arrangement includes a sleeve which is arranged, in use, to locate between an inner surface of the collar and outer surface of the inner tubular member. Preferably the sleeve comprises a compression sleeve.

Preferably the arrangement includes movement means for moving the annular component relative to the collar. Preferably the movement means comprises hydraulic movement means.

The clamping arrangement may comprise hydraulic fluid introduction means to introduce hydraulic fluid into the chamber in order to urge the annular component relative to the collar.

The movement means may comprise a piston. Preferably the movement means comprises a plurality of pistons. Preferably the pistons are arranged radially around the annular component.

The clamping arrangement may comprise locking means to lock the annular component in the second position. The locking means may comprise a locking member which engages in a locking recess. Preferably the locking means comprises a plurality of locking members.

The clamping arrangement may comprise return movement means to move the annular component from the second position towards the first position. In particular, the return movement means may aid the release of the clamping force from between the annular component and the collar.

Preferably the return movement means comprises a chamber which may be pressurised to urge the annular component relative to (away from) the collar.

The movement means may comprise a piston. Preferably the movement means comprises a plurality of pistons. Preferably the pistons are arranged radially around the annular component.

According to a second aspect of the present invention there is provided a method of calculating the load capacity of a wellhead system, the wellhead system comprising a clamping arrangement comprising a collar having an externally tapered surface, the arrangement also including an annular component with an internally tapered surface, the collar and the annular component being relatively axially moveable between a first position in which the tapered surface of the annular component exerts no radial force on the collar and a second position in which the tapered surface of the annular component exerts sufficient radial force to distort the collar inwardly in order to grip an inner tubular member within an outer tubular member to support a load of the inner tubular member, the inner tubular member having an outer surface including a ridged profile, and the method comprising:
determining a first contact stress at a first interface between the annular component and the collar, by equating a radial deflection of an inner surface of the annular component with a radial deflection of an outer surface of the collar;
determining a second contact stress at a second interface between the collar and the outer tubular member assuming negligible hoop stiffness of the collar; and
using the first contact stress, the second contact stress and the axial movement of the annular component to determine a contact stress at a third interface between the outer tubular member and the inner tubular member, by equating a radial deflection of the outer surface of the inner tubular member with (i) a radial deflection of an inner surface of the outer tubular member plus (ii) a depth of penetration of a ridge of the outer surface of the inner tubular member into an inner surface of the outer tubular member plus (iii) a radial dimension of an initial gap between the outer surface of the inner tubular member and the inner surface of the outer tubular member.

The present invention may comprise constructing and/or designing a wellhead comprising:
calculating a load requirement of the wellhead;
calculating the load capacity of a wellhead system in accordance with the first or second aspect of the present invention;
constructing the wellhead by selecting a combination of a clamping arrangement and inner tubular member to provide said load capacity for the wellhead.

The method may comprise selecting a material and dimensions for:
the collar;
the annular component;
the inner tubular member; and
the gripping surface.

### BRIEF DESCRIPTION OF THE DRAWINGS

The invention will now be further described by way of example only and with reference to the accompanying drawings, in which:

FIG. 1 is a sectional view of a first clamping system in a wellhead system;

FIGS. 2a and 2b are schematic diagrams of the first clamping system of FIG. 1 in a released and an activated configuration, respectively;

FIG. 3 is a sectional view of a second clamping system in a wellhead system;

FIGS. 4a and 4b are schematic diagrams of the second clamping system of FIG. 3 in a released and an activated configuration, respectively;

FIG. 5 is a schematic diagram of a part of the second clamping system of FIG. 3, in the released (deactivated) configuration;

FIG. 6 is a schematic diagram of a part of the second clamping system of FIG. 3, in the activated configuration, and in which two compression rings of the clamping system are identical;

FIG. 7 is a schematic diagram of a part of the second clamping system of FIG. 3, in the activated configuration, and in which each of the two compression rings of the clamping system have a different stiffness;

FIG. 8 illustrates a first contact stress (Q3) viewed on a cross-section through a slotted hanger, where the force applied to the hanger is averaged over the entire circumference of the hanger;

FIG. 9 illustrates a second contact stress (Q3ₜₑₑₜₕ) viewed on a cross-section through a slotted hanger, where the force applied to the hanger is averaged over the non-slotted regions of the hanger; and

FIG. 10 illustrates a third contact stress (Q3ₛₗₒₜ), namely the contact stress at the bottom or base of the slots, viewed on a cross-section through a slotted hanger.

### DESCRIPTION OF THE PREFERRED EMBODIMENTS

A wellhead system 2 comprises a plurality of interacting components in a wellhead. The wellhead system typically comprises casing or tubing heads, hangers, annular seals and conductor housings (in subsea wellhead systems). Casing heads are configured to suspend and seal a casing string. Casing strings and production tubing may be referred to more generally as tubulars 4. Casing strings or tubulars 4 extend through a wellbore and are arranged concentrically, with smaller diameter casing strings or tubulars 4 being mounted and supported within larger diameter casing strings or tubulars 4. In the following description, the term tubular member 6 is also used to encompass a hanger 8 used to support a casing string 4.

A clamping system 10 may be used to grip an upper end of an inner tubular 4 with the inner tubular 4 then extending downwardly in an outer tubular 4 so as to support the load of the inner tubular 4 and effect sealing between the inner and outer tubulars 4. As mentioned above, the clamping system 10, 110, 210 comprises a friction grip system and specifically a friction grip wellhead system. Such a system uses (and relies solely upon) a frictional grip to secure components in a bore of a concentric tubular member. This system enables a tubular member to be easily and reliably landed and connected within the wellhead system and allows the inner tubular member to be released and re-secured or removed for a variety of reasons. Furthermore, this system enables the gripped tubular member to be locked down with the wellhead system. The frictional grip prevents the inner tubular member from moving downwardly or upwardly. Finally, this system also provides a reliable and effective seal around the inner tubular member.

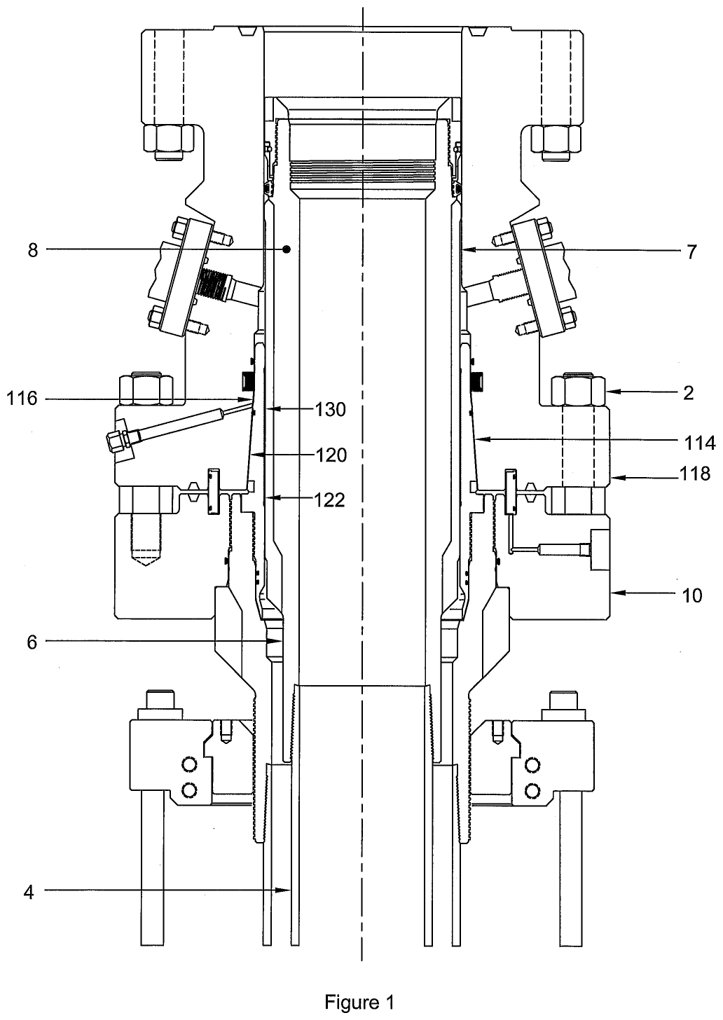

FIGS. 1 to 4 show two types of clamping systems 110, 210 employed in a wellhead system 2. These clamping systems 110, 210 use axial movement of one or more components over a taper to compress inner components radially inwards within the elastic range of the compressed materials to “grip” inner components. In particular, the clamping systems 110, 210 may be used to apply a radial force to an outer gripping member (outer casing, conductor, collar) to directly or indirectly grip an inner tubular or inner casing 4. Contact stresses created by the gripping action support the load of the inner tubular 4 through a friction interface 130, 230. The gripping action may also energise annular seals. As mentioned above, this creates an effective seal and also locks down the inner casing 4 whilst also enable the inner casing 4 to be easily released and removed.

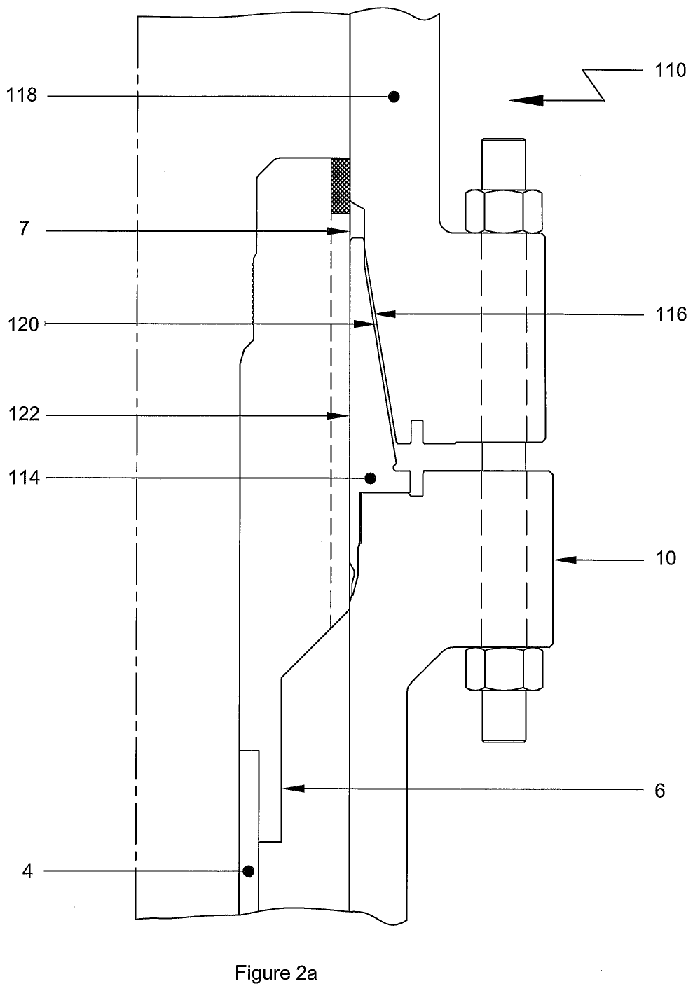

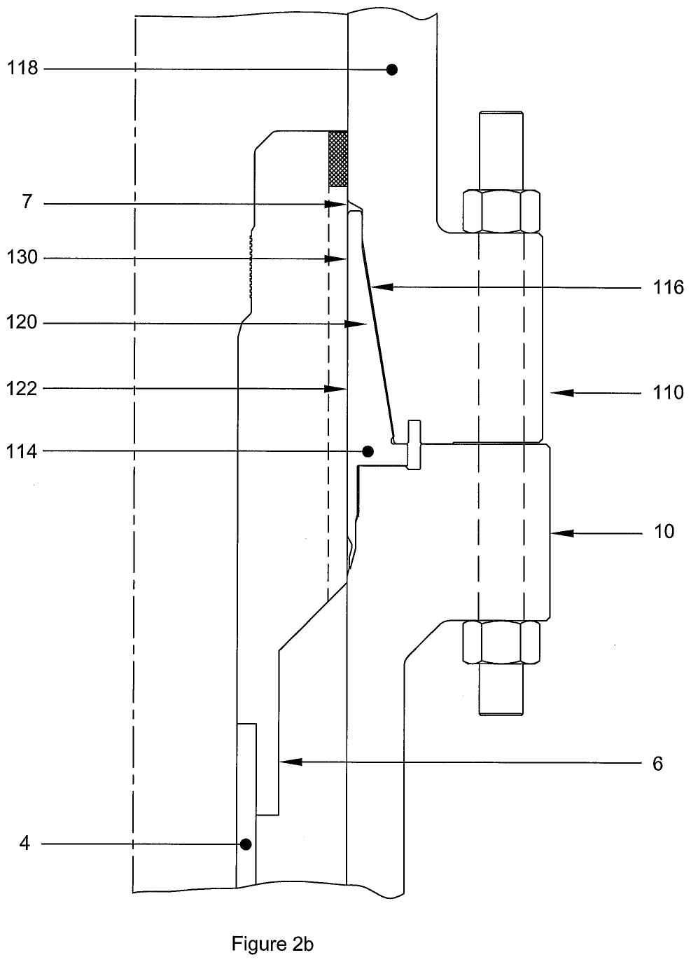

In a first clamping system or first clamping arrangement 110, shown in FIGS. 1 and 2, the clamping system 110 is disposed at an interface between two casing or tubing heads or spools. The first clamping system 110 comprises an annular collar element 114 having a tapered or ramped outer surface 116. An inner tubular member 6 is disposed within and through the collar element 114. The first clamping system 110 also includes an activating spool 118 that is arranged to move axially over at least a section of the tapered surface 116 of the collar element 114. The activating spool 118 is therefore disposed radially outside of the collar element 114. The activating spool 118 comprises a radially inner surface 120 that is tapered, and that engages with the outer tapered surface 116 of the collar element 114. The first clamping system 110 is activated by moving the activating spool 118 (or first casing or tubing head) axially over the collar element 114 in a first direction which causes the collar element 114 to deflect radially inwardly so as to grip the inner tubular member 4. In this clamping system 110 an inner surface 122 (the gripping surface) of the collar element 114 is in contact with an outer surface 7 of the inner tubular member 6. To release the inner tubular member 6, the activating spool 118 is moved in a second, opposite direction. The activating spool 118 no longer applies a compression force to the collar element 114, and the collar element 114 elastically returns to its original size. The inner tubular member 6 is then free to move through the collar element 114, for removal purposes, repositioning and the like. FIG. 2a shows the first clamping arrangement 110 in its activated configuration and FIG. 2b shows the first clamping arrangement 110 in its released configuration.

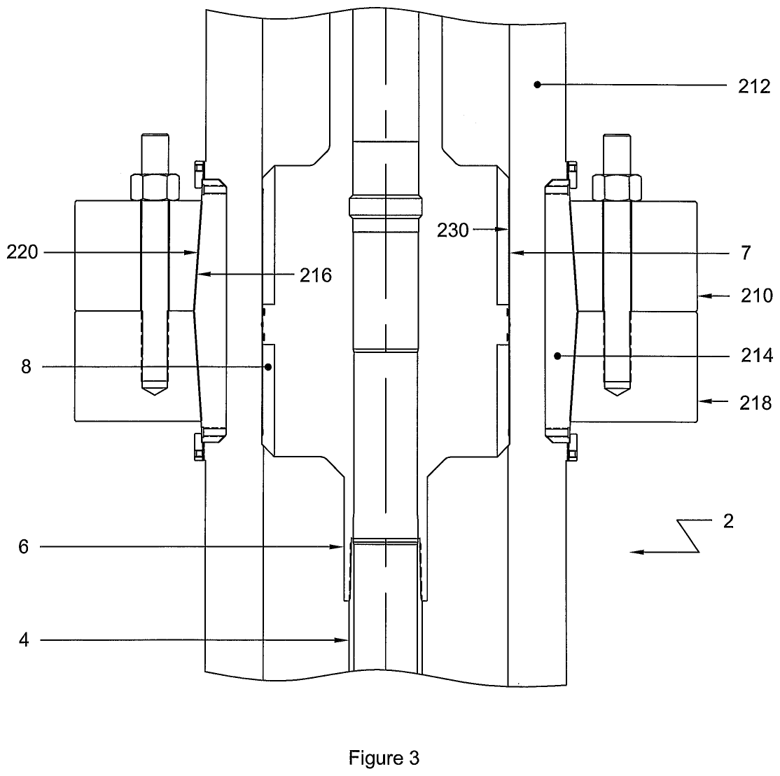

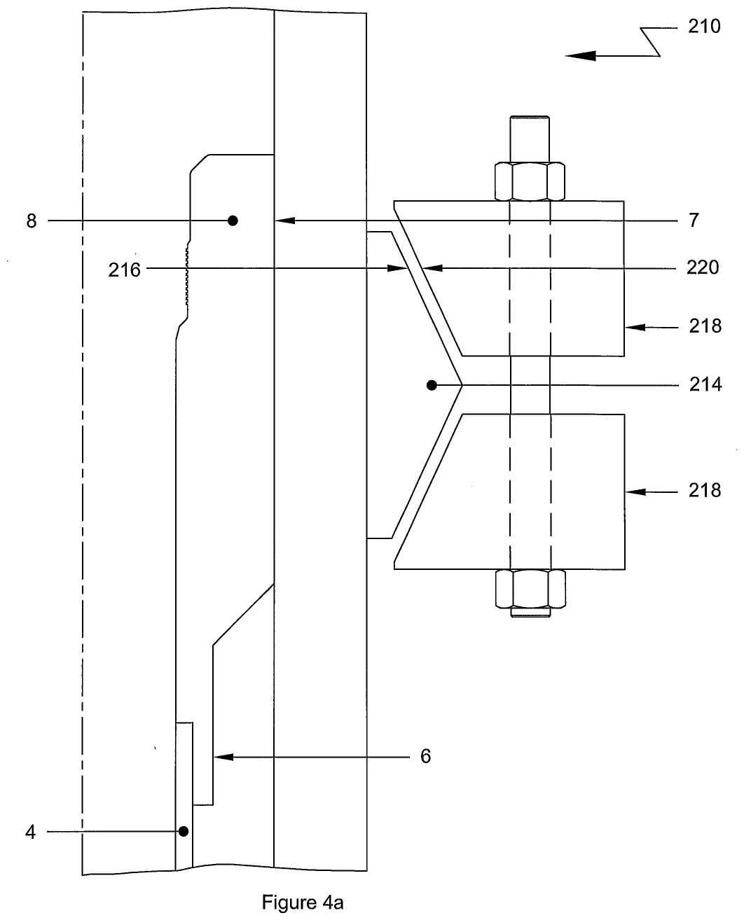

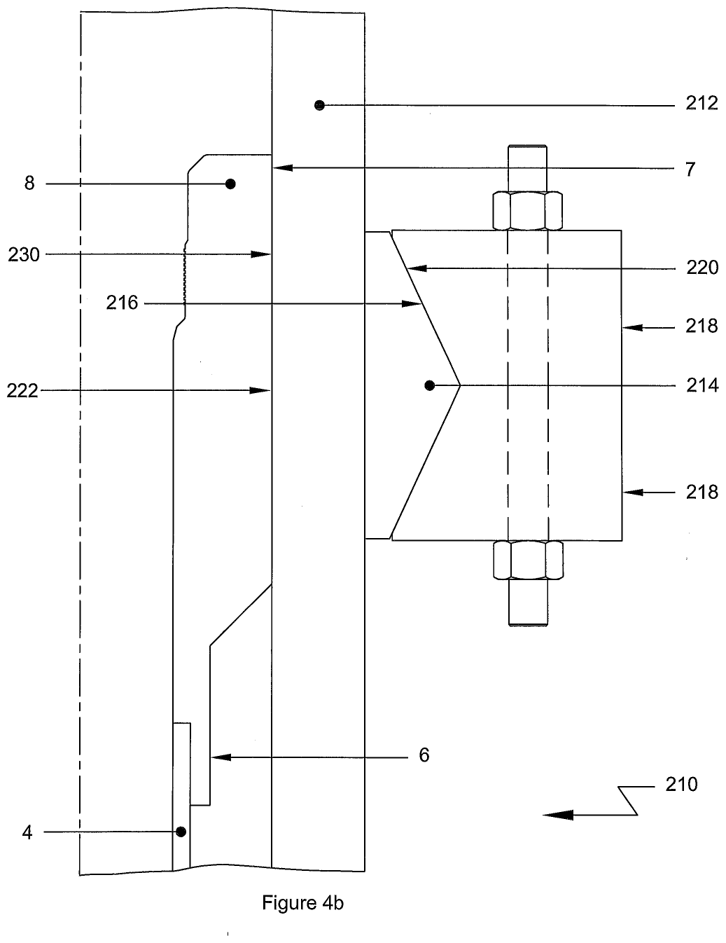

A second clamping system or second clamping arrangement 210, shown in FIGS. 3 and 4, is disposed or situated away from an end of a casing or tubing head. The second clamping system 210 comprises an annular compression collar 214 having a tapered or ramped outer surface 216. A housing body or conductor housing 212 is disposed within and through the compression collar 214. An inner tubular member 6 is disposed and supported within the housing body or conductor housing 212. The second clamping system 210 also includes at least one compression ring 218 disposed radially outside of the compression collar 214. The compression ring 218 comprises a radially inner surface 220 that is tapered, and that engages with the outer tapered surface 216 of the compression collar 214. The second clamping system 210 is activated by moving the compression ring 218 axially over the compression collar 214 in a first direction which causes the compression collar 214 to deflect radially inwardly. The compression collar 214 applies a radial force to the housing body or conductor housing 212 so as to elastically inwardly compress the housing body or conductor housing 212 and an inner surface (the gripping surface) of the outer tubular member/conductor housing 212 grips the inner tubular member 6. To release the inner tubular member 6, the compression ring 218 is moved in a second, opposite direction. The compression ring 218 no longer applies a compression force to the compression collar 214 and the housing body or conductor housing 212. The inner tubular member 6 is then free to move through the housing body or conductor housing 212, for removal repositioning and the like. FIG. 4a shows the second clamping arrangement 210 in its activated configuration and FIG. 4b shows the second clamping arrangement 210 in its released configuration.

It will be appreciated from the foregoing description that, although the components of the first and second clamping system 110, 210 are different, their principle of operation and the resulting clamping action is substantially the same. Each clamping system or clamping arrangement 110, 210 comprises a collar 114, 214 having an externally tapered surface 116, 216. Each clamping system or arrangement 110, 210 also includes an annular component 118, 218 with an internally tapered surface 120, 220, the collar 114, 214 and the annular component 118, 218 being relatively axially moveable between a first position in which the tapered surface 120, 220 of the annular component 118, 218 exerts no radial force on the collar 114, 214 and a second position in which the tapered surface 120, 220 of the annular component 118, 218 exerts sufficient radial force to distort the collar 114, 214 inwardly in order to grip an inner tubular member 6 within a gripping surface (e.g. provided on an outer tubular member 212/collar 114) to support a load of the inner tubular member 6.

It will be appreciated that a load acting on the inner tubular member 6 is generally in an axial direction, whilst the force applied to the inner tubular member 6 by the clamping system 110, 210 is in a generally radial direction. Accordingly, the friction interface 130, 230 is defined between the outer surface 7 of the inner tubular member 6 and an inner surface of the clamping system 110, 210 (the inner surface 122 (gripping surface) of the collar element 114 in the first clamping system 110 and an inner surface 222 (gripping surface) of the housing body or conductor housing 212 in the second clamping system 210).

In order to determine a load capacity of the clamping system 110, 210, that is, the maximum load that may be safely supported by the clamping system 110, 210, it is necessary to determine the radial compression forces (contact stresses) between each of the components of the clamping system 110, 210.

When a clamping system 110, 210 is activated, the components of the system 110, 210 will deform radially until all adjacent components are in contact, developing contact stresses at each interface.

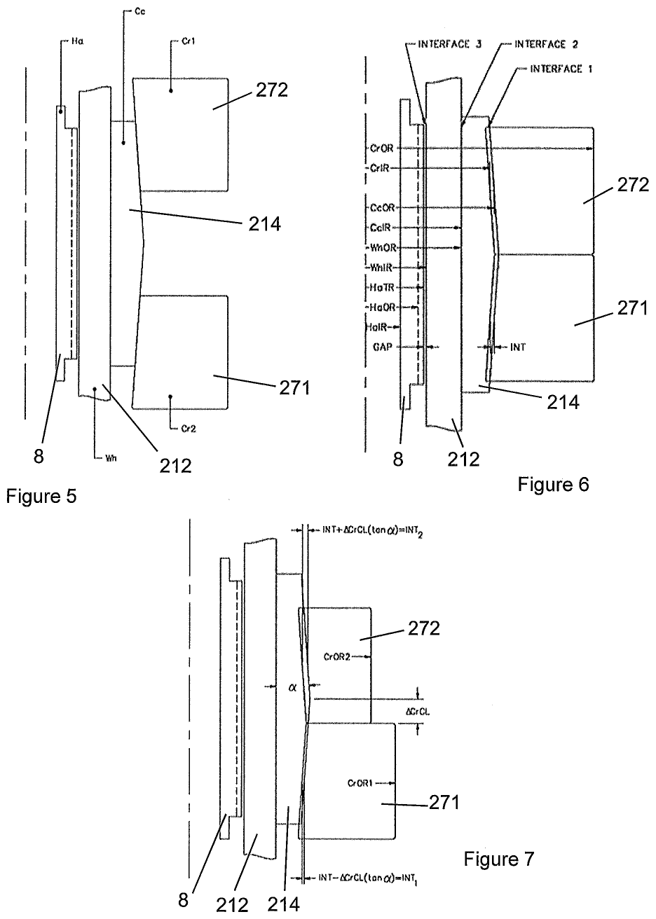

In the preferred embodiments of the clamping systems shown in FIGS. 1 to 4, there are two or three interfaces. As shown in FIG. 6, the second clamping system 210 (shown further in FIG. 5) comprise three interfaces referred to as Interface 1, Interface 2 and Interface 3 (the gripping interface).

Interface 1 relates to the interface between the compression ring 218 and the compression collar 214. Interface 2 relates to the interface between the compression collar 214 and the housing body 212. Finally, Interface 3 (the gripping interface) relates to the interface between the housing body 212 and the hanger 8.

In the first embodiment of the clamping system shown in FIG. 1 and FIG. 2, there are two interfaces. Interface 1 relates to the interface between the compression ring 118 and the compression collar 114. Interface 2 (the gripping interface) relates to the interface between the compression collar and the hanger 8. Accordingly, the calculation for the first clamping system is simpler and the present invention will now be described further with particular reference to the second clamping system including three interfaces. It will be appreciated that the same calculation method can be applied to the first clamping system by omitting Interface 2.

In the method according to the present invention, it is assumed that each of the components of the clamping system 110, 210 are simple cylindrical components. Furthermore, the method is predicated upon assuring compatibility of radial displacements at the interfaces of all cylindrical components in contact. For any two deforming components in contact, the total radial deformations at the interface between the components must sum to zero. If the radial deformations summed to a value greater than zero then the components would “interfere”, which is physically impossible. If the radial deformations summed to a value less than zero then a gap would develop between the components, which is at odds with a starting assumption that the components must be in contact.

An example calculation to determine contact stress will now be described with particular reference to the second clamping system 210. FIGS. 5 to 7 illustrate the components of the clamping system 210 and the interfaces considered in the following calculations.

### Interface 1—Displacement Compatibility

A radial deflection of the inner surface 220 of the compression ring 218 must equal the radial deflection of the outer surface 216 of the compression collar 214, plus any “interference” that would be present if these components were brought together with no deflections present. The compression ring 218 must therefore effectively expand radially so that it fits over the “interference” with the compression collar 214. Further effective expansion of the compression ring 218 is then also considered to take account of or allow for any radial expansion of the compression collar 214.

This is expressed as follows for each compression ring:

$$Δ CrIR 1 = Δ CcOR + {Int}_{1} \qquad Eq . 1$$

$$Δ CrIR 2 = Δ CcOR + {Int}_{2} \qquad Eq . 2$$

ΔCrIR1 is the radial deflection of the inner radius of a first one of the two compression rings 271, 272 due to contact stresses and/or pressures present radially inside or outside this compression ring 271, 272.

ΔCrIR2 is the radial deflection of the inner radius of a second one of the two compression rings 271, 272 due to contact stresses and/or pressures present radially inside or outside this compression ring 271, 272.

In situations in which the stiffness of each of the two compression rings 271, 272 is different, the first compression ring 271 will typically be the stiffer of the two compression rings 217, 272 and the second compression ring 272 will typically be the less stiff of the two compression rings.

ΔCcOR is the radial deflection of the outer radius of the compression collar 214 due to any contact stresses and/or pressures present radially inside or outside the compression collar 214.

Int₁ is the “interference” present along the tapered interface between the compression collar 214 and the first one of the compression rings 271 when the clamping system 210 is fully activated, assuming no radial deformation of the components.

Int₂ is the “interference” present along the tapered interface between the compression collar 214 and the second one of the compression rings 272 when the clamping system 210 is fully activated, assuming no radial deformation of the components.

The inner radius of each of the compression rings 271, 272 and the outer radius of the compression collar 214 are preferably measured in a neutral, un-deformed state of each of the components. Furthermore, the value for the outer radius of the compression collar 214 is preferably taken as an average value along the tapered length of the compression collar 214, and the value for the inner radius of each of the compression rings 271, 272 is preferably taken as an average value along the tapered length of the compression ring 218. In this example the inner radius of both of the compression rings 271, 272 is assumed to be identical.

If both compression rings 271, 272 are equally stiff, a number of variables can be simplified:

$${Int}_{1} = {Int}_{2} = Int \qquad Eq . 3$$

$$Δ CrIR 1 = Δ CrIR 2 = Δ CrIR \qquad Eq . 4$$

Combining equations 1 to 4 gives equation 5 for the displacement compatibility at Interface 1 when the compression rings 271, 272 are of equal stiffness:

$$Int = Δ CrIR - Δ CcOR \qquad Eq . 5$$

If the stiffness of each of the upper and lower compression rings 271, 272 is different, then the less stiff compression ring (second compression ring 272) will expand more under a given load, thus travelling further down the tapered outer surface of the compression collar 214 than the stiffer of the two compression rings (first compression ring 271) (see FIG. 7). Mathematically, ΔCrIR1 #ΔCrIR2. Similarly, the “interference” present on each compression ring 271, 272 would differ (so Int1≠Int2). The final “interference” present for each compression ring 271, 272 in this situation would then depend upon the difference in the axial travel of each ring, as given by equations 6 and 7:

$${Int}_{1} = Int - Δ CrCL ( tan α ) \qquad Eq . 6$$

$${Int}_{2} = Int + Δ CrCL ( tan α ) \qquad Eq . 7$$

Where,

ΔCrCL is the axial distance between the centre of the compression collar 214 and the plane at which the compression rings 271, 272 of unequal stiffness come into contact when activated. It will be appreciated that when the compression rings 271, 272 are of equal stiffness, and can therefore be assumed to travel equal distances along the tapered outer surface of the compression collar 214, ΔCrCL equals zero. α is the angle of taper of the compression rings 271, 272 and the compression collar 214, with respect to the vertical.

Combining equations 1, 2, 6 and 7 results in the following equations for displacement compatibility at Interface 1 when the compression rings 271, 272 are of unequal stiffness:

$$Int - Δ CrCL ( tan α ) = Δ CrIR 1 - Δ CcOR \qquad Eq . 8$$

$$Int + Δ CrCL ( tan α ) = Δ CrIR 2 - Δ CcOR \qquad Eq . 9$$

The following example calculation assumes that the compression rings 271, 272 are of equal stiffness.

### Interface 2—Displacement Compatibility

In this example the compression collar 214 is split into segments allowing it to be assembled onto the housing body 212 with no gap between the inner surface of the compression collar 214 and the outer surface of the housing body 212, at Interface 2. Therefore, any deflection of these components at this interface must be the same:

$$Δ WhOR = Δ CcIR \qquad Eq . 10$$

where,

ΔWhOR is the radial deflection of the outer radius of the gripped section of the housing body 212 due to contact stresses and/or pressures present radially inside or outside the gripped section of the housing body 212.

ΔCcIR is the radial deflection of the inner radius of the compression collar 214 due to contact stresses and/or pressures present radially inside or outside the compression collar 214.

The inner radius of the compression collar 214 and the outer radius of the gripped section of the housing body 212 are preferably measured in a neutral, un-deformed state of each of the components. Furthermore, the value for the inner radius of the compression collar 214 is preferably taken as an average value along the tapered length of the compression collar 214.

Any radial deflection at the inner surface of the compression collar 214 will be identical to the radial deflection at the outer surface 216 of the compression collar 214, less any “thinning” of the compression collar (ΔCcT), as described later.

$$Δ CcIR = Δ CcOR - Δ CcT \qquad Eq . 11$$

The displacement compatibility at Interface 2 is then:

$$Δ CcOR = Δ CcT + Δ WhOR \qquad Eq . 12$$

### Interfaces 1 and 2—Relating Deflections to Contact Stresses

Most of the radial deflection terms in equations 8, 9 and 12 are for cylinders. For these variables (“ΔCrIR1”, “ΔCrIR2”, and “ΔWhOR”), the standard engineering relationship for a cylinder subjected to internal and external pressure may be used. For a general cylinder of outer radius “OR” and inner radius “IR”, made of material with a Young's Modulus of “E” and Poisson's ratio of “ν”, subjected to an internal pressure of “Qᵢₙₜ” and an external pressure of “Qₑₓₜ”, the radial deflections of the inner and outer radii are given by:

$$Δ OR = \frac{{Q}_{int}}{E} \times ( \frac{2 \times OR \times {IR}^{2}}{{OR}^{2} - {IR}^{2}} ) + \frac{- {Q}_{ext} \times OR}{E} \times ( \frac{{OR}^{2} + {IR}^{2}}{{OR}^{2} - {IR}^{2}} - v ) \qquad Eq . 13$$

$$Δ IR = \frac{{Q}_{int} \times IR}{E} \times ( \frac{{OR}^{2} + {IR}^{2}}{{OR}^{2} - {IR}^{2}} + v ) + \frac{- {Q}_{ext}}{E} \times ( \frac{2 \times {OR}^{2} \times IR}{{OR}^{2} - {IR}^{2}} ) \qquad Eq . 14$$

Using equations 13 and 14 applied to the compression rings 271, 272 and the housing body 212, the variables “ΔCrIR1”, “ΔCrIR2”, and “ΔWhOR” can be expressed in terms of contact stresses “Q1”, “Q2”, and “Q3”, and the geometry and materials of the parts being analysed. Q1 is the contact stress at Interface 1, Q2 is the contact stress at Interface 2 and Q3 is the contact stress at Interface 3.

The term “ΔCcT” in equation 12 is unique as it is a deflection term for a split component, rather than a solid cylindrical component. Because the compression collar 214 is split into segments, it can be assumed that there is negligible hoop stiffness resisting deflection of the parts. This component may therefore be treated as a “plate” of material subject to a compressive load due to activation of the clamping system 210. The compression will result in “thinning” of the compression collar 214, the amount of which can be determined by simple application of Hooke's law, remembering that the contact stress “Q1” is positive when it is compressive:

$$Q 1 = {E}_{Cc} \times ( \frac{- Δ CcT}{CcOR - CcIR} ) \qquad Eq . 15$$

rearranging to solve for ΔCcT:

$$Δ CcT = \frac{- Q 1 \times ( CcOR - CcIR )}{{E}_{Cc}} \qquad Eq . 16$$

where E_{Cc} is the Young's modulus of the compression collar 214.

It is also noted that in this split region, the applied compressive force may be assumed to be applied with negligible losses. Accordingly, the force applied at the outside of the slotted cylindrical region may be assumed to be identical to the force at the inside of the slotted cylindrical region. If the force is assumed to be identical, then the contact stress will be decreased by the ratio of the inside surface area to the outside surface area. This allows determination of contact stress “Q1”:

$$Q 1 = Q 2 \times ( \frac{CcIR}{CcOR} ) \qquad Eq . 17$$

### Interface 3—Displacement Compatibility

At Interface 3 (the gripping interface), it is easier to envisage the hanger 8 moving outwards instead of the housing body 212 being compressed inwards, as this assumption makes all movements occur in the “positive” direction. The equation produced is equally valid regardless of whether the components involved are moving inwards or outwards. As the hanger 8 expands outwards to contact the housing body bore, the hanger radial deflection must equal the radial gap present initially between the hanger 8 and the housing body 212, plus any outwards radial deflection of the inner surface of the housing body 212. In many wellhead systems the outer surface of the hanger 8 includes a toothed profile.

If one of the surfaces at an interface between components of the clamping system 110, 210 features a toothed profile, then the teeth will bite into the corresponding mating surface at the interface upon activation of the clamping system 110, 210.

The depth of bite will depend upon a number of factors including, but not limited to:
The contact stress applied to the interface
The geometry of the teeth (including tooth pitch, tooth height, and tooth angles).
The hardness of the teeth.
The hardness of the mating surface

Since one of the components must deflect over a greater radial distance as the bite occurs, the contact stress will differ from the contact stress that would be present if both components were without teeth.

Accordingly, the hanger radial deflection will also include the depth that the hanger toothed profile bites into the housing as they come into contact.

$$Δ HaTR = Gap + Bite + Δ WhIR \qquad Eq . 18$$

ΔHaTR is the radial deflection of the outer radius of the gripped section of the hanger 8 (across the tooth tips) due to any contact stresses and/or pressures present radially inside or outside the gripped section of the hanger 8.

Gap is the initial gap present between the housing body inner radius and the hanger outer radius. Gap=WhIR−HaTR.

Bite is the depth of the indentation of the toothed surface on the outside of the hanger 8 into the smooth bore of the housing body 212.

ΔWhIR is the radial deflection of the inner radius of the gripped section of the housing body 212 due to any contact stresses and/or pressures present radially inside or outside the gripped section of the housing body 212.

The inner radius of the gripped section of the housing body 212 is preferably measured in a neutral, un-deformed state.

In some embodiments the outer surface of the hanger 8 is slotted. In these circumstances “ribs” of material are left between the slots. As these ribs have no hoop stiffness, they will compress or expand in a different manner to the compression or expansion of the solid cylindrical hanger body beneath the slots. This is taken into account by breaking “ΔHaTR” into its component parts. ΔHaTR comprises the radial expansion or compression of the solid section of the hanger body and the radial expansion or compression of the ribs.

$$Δ HaTR = Δ HaOR + Δ Rib \qquad Eq . 19$$

ΔHaOR is the radial deflection of the outer radius of the gripped section of the hanger body across the bottom of any slots through the toothed outer surface due to any contact stresses and/or pressures present radially inside the gripped section of the hanger or at the bottom of the slots in the gripped section of the hanger 8. ΔRib is the radial compression of the ribs on the hanger outer surface due to radially applied compressive contact stresses.

Equation 18 then becomes:

$$Δ HaOR + Δ Rib = Gap + Bite + Δ WhIR \qquad Eq . 20$$

### Interface 3—Relating Deflections to Contact Stresses

For all of the terms in Equation 20 related to the hanger 8 (namely “ΔHaOR”, “ΔRib”, and “Bite”), consideration must be given to the areas over which the contact force acts before these can be expressed in terms of contact stresses. Complexity is present in these relationships due to the presence of slots on the outside of the hanger 8. Taking these slots, and the ribs of material in between them, into consideration, there are three separate contact stresses requiring definition:
Q3—the contact stress at Interface 3
Q3ₛₗₒₜ—the average radial contact stress taken over the entire circumference at the bottom of the slots on the outer diameter of the hanger 8
Q3ₜₑₑₜₕ—the average radial contact stress at Interface 3, averaged over the non-slotted (ribbed) regions of the hanger outer diameter.

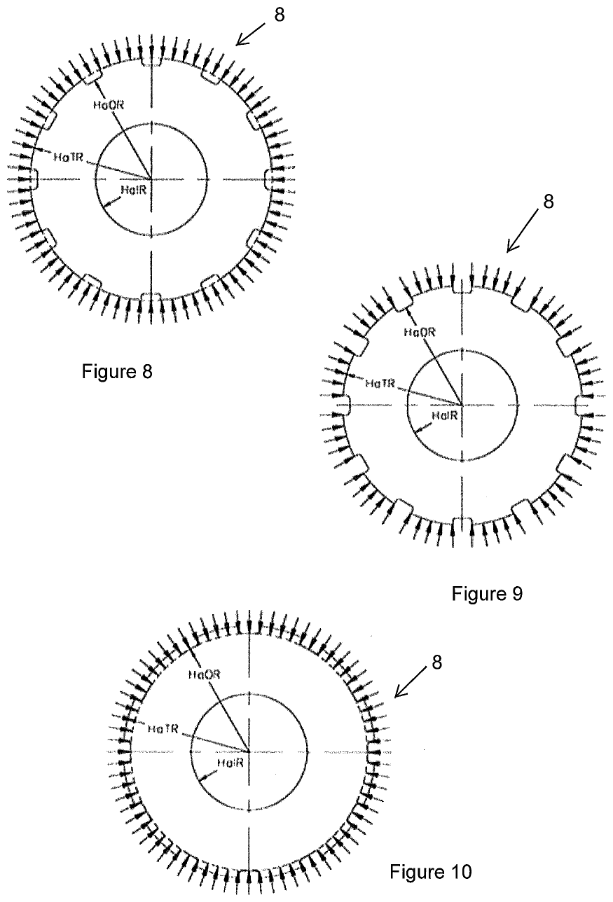

This is illustrated in FIGS. 8 to 10.

“Q3” can be related to “Q3ₜₑₑₜₕ” quite simply. The force that is averaged over the entire (non-slotted) circumference of the hanger in “Q3” is averaged only over the non-slotted regions in “Q3ₜₑₑₜₕ”. Mathematically:

$$Q {3}_{teeth} = \frac{Q 3}{( 1 - \% R )} \qquad Eq . 21$$

Where %R is the percentage of the hanger circumference that has been removed by the inclusion of slots on the hanger outer diameter.

“Q3” can be related to “Q3ₛₗₒₜ” because, much like the split compression collar discussed above, the slotted region of the hanger 8 will transmit compressive forces with negligible losses. If the force at the top of the slots and at the bottom of the slots is identical, then the contact stress at the bottom of the slots will be increased by the ratio of the area at the top of the slots to the area at the bottom of the slots.

$$Q {3}_{slot} = Q 3 \times ( \frac{HaTR}{HaOR} ) \qquad Eq . 22$$

However, the simple relationship of Equation 22 isn't quite so simple in the general case where the hanger 8 is subject to both contact stress and applied fluid pressure at interface 3. In this case, the applied fluid pressure (P3) acts directly on the bottom of the slots, while the contact stress and fluid pressure combined act on the “ribbed” regions between the slots. This can be expressed mathematically, for the total contact stress acting at the circumference at the bottom of the slots on the hanger, by:

$$Q {3}_{slot} = ( \% R \times P 3 ) + [ ( 1 - \% R ) \times ( Q {3}_{teeth} + P 3 ) \times ( \frac{HaTR}{HaOR} ) ] \qquad Eq . 23$$

Note that Equation 23 collapses to equation 22 if “P3” is zero.

With both “Q3ₜₑₑₜₕ” and “Q3ₛₗₒₜ” determined, it is possible to relate the hanger displacement terms in Equation 20 to contact stresses.

First, “ΔHaOR”, the radial displacement of the outside of the solid cylindrical section of the hanger 8, can be expressed using Equations 13 and 14 applied to the hanger 8, recognizing that the contact stress acting at the outside of the solid cylindrical section of the hanger is “Q3ₛₗₒₜ”, as defined in Equation 23. Combining Equations 13, 14 and 23 allows expression of “ΔHaOR” in terms of Q3, bore pressure inside the hanger 8, and the geometry and materials of the hanger 8.

Next, as mentioned earlier, the “ribs” of material between the slots have negligible hoop stiffness. The ribs on the hanger 8 may therefore be treated as a plate of material subject to a compressive load due to activation of the clamping system 110, 210. The compression will effectively result in thinning of the ribs, the amount of which can be determined by application of Hooke's law, remembering that the contact stress acting on the outside of the ribs is “Q3ₜₑₑₜₕ” plus any applied fluid pressure (P3).

$$( Q {3}_{teeth} + P 3 ) = {E}_{Ha} \times ( \frac{- Δ Rib}{HaTR - HaOR} ) \qquad Eq . 24$$

Where, E_{Ha} is the Young's modulus of the hanger 8.

Rearranging Equation 24 to solve for “ΔRib”, and substituting in Equation 21 for “Q3ₜₑₑₜₕ” allows “ΔRib” to be expressed in terms of “Q3”.

$$Δ Rib = ( \frac{- ( \frac{Q 3}{( 1 - \% R )} + P 3 ) \times ( HaTR - HaOR )}{{E}_{Ha}} ) \qquad Eq . 25$$

Lastly, a relationship for Bite as a function of Q3 must be determined. This example assumes that the Bite is a linear function of Q3ₜₑₑₜₕ in the form:

$$Bite = BC 1 \times Q {3}_{teeth} + BC 2 \qquad Eq . 26$$

Where, BC1 and BC2 are constants.

Combining Equations 26 and 21 gives Equation 27 for the linear bite at a slotted interface in terms of contact stress Q3.

$$Bite = \frac{BC 1 \times Q 3}{( 1 - \% R )} + BC 2 \qquad Eq . 27$$

### System of Solvable Equations

From the above equations, a system of four equations can be established:

$$Δ CrIR 1 - Δ CcT - Δ WhOR - Int + Δ CrCL ( tan α ) = 0 \qquad Eq . 28$$

$$Δ CrIR 2 - Δ CcT - Δ WhOR - Int + Δ CrCL ( tan α ) = 0 \qquad Eq . 29$$

$$Δ WhIR + Gap + Bite - Δ HaOR - Δ Rib = 0 \qquad Eq . 30$$

$$Q 1 = Q 2 \times ( \frac{CcIR}{CcOR} ) \qquad Eq . 17$$

All of the variables in these four equations can be expressed in terms of contact stress and geometry. Such that:

$$Q 3 = \frac{( 2 \times {K}_{3} \times {Wh}_{2} ) - ( {K}_{1} \times {K}_{4} ) - ( {K}_{1} \times {K}_{5} )}{( {K}_{2} \times {K}_{4} ) + ( {K}_{2} \times {K}_{5} ) - ( 2 \times {Wh}_{2} \times {Wh}_{3} )} \qquad Eq . 31$$

$$Q 2 = \frac{( 2 \times {K}_{3} ) + ( 2 \times {Wh}_{3} \times Q 3 )}{{K}_{4} + {K}_{5}} \qquad Eq . 32$$

$$Q 1 = Q 2 \times ( \frac{CcIR}{CcOR} ) \qquad Eq . 17$$

$$Δ CrCL = \frac{{K}_{3} + ( {Wh}_{3} \times Q 3 ) - ( {K}_{4} \times Q 2 )}{tan α} \qquad Eq . 33$$

In which,

$${K}_{1} = P 3 \times [ {Wh}_{1} + ( {Ha}_{2} \times \% R ) + ( {Ha}_{2} \times \frac{HaTR}{HaOR} \times ( 1 - \% R ) + \frac{( HaTR - HaOR )}{{E}_{Ha}} ) ] + Gap + BC 2 - ( {Ha}_{1} \times {P}_{bore} ) \qquad Eq . 34$$

$${K}_{2} = {Wh}_{1} + \frac{BC 1}{1 - \% R} + ( {Ha}_{2} \times \frac{HaTR}{HaOR} ) + ( \frac{( HaTR - HaOR )}{{E}_{Ha} \times ( 1 - \% R )} ) \qquad Eq . 35$$

$${K}_{3} = Int + ( ( \frac{2 \times WhOR \times {WhIR}^{2}}{{E}_{Wh} \times ( {WhOR}^{2} - {WhIR}^{2} )} ) \times P 3 ) \qquad Eq . 36$$

$${K}_{4} = {Cr}_{1} + Cc + {Wh}_{4} \qquad Eq . 37$$

$${K}_{5} = {Cr}_{2} + Cc + {Wh}_{4} \qquad Eq . 38$$

$${Ha}_{1} = \frac{2 \times HaOR \times {HaIR}^{2}}{{E}_{Ha} \times ( {HaOR}^{2} - {HaIR}^{2} )} \qquad Eq . 39$$

$${Ha}_{2} = \frac{HaOR}{{E}_{Ha}} \times ( \frac{{HaOR}^{2} + {HaIR}^{2}}{{HaOR}^{2} - {HaIR}^{2}} - {v}_{Ha} ) \qquad Eq . 40$$

$${Wh}_{1} = \frac{WhIR}{{E}_{Wh}} \times ( \frac{{WhOR}^{2} + {WhIR}^{2}}{{WhOR}^{2} - {WhIR}^{2}} - {v}_{Wh} ) \qquad Eq . 41$$

$${Wh}_{2} = \frac{2 \times {WhOR}^{2} \times WhIR}{{E}_{Wh} \times ( {WhOR}^{2} - {WhIR}^{2} )} \qquad Eq . 42$$

$${Wh}_{3} = \frac{2 \times WhOR \times {WhIR}^{2}}{{E}_{Wh} \times ( {WhOR}^{2} - {WhIR}^{2} )} \qquad Eq . 43$$

$${Wh}_{4} = \frac{WhOR}{{E}_{Wh}} \times ( \frac{{WhOR}^{2} + {WhIR}^{2}}{{WhOR}^{2} - {WhIR}^{2}} - {v}_{Wh} ) \qquad Eq . 44$$

$${Cr}_{1} = \frac{CrIR}{{E}_{Cr 1}} \times ( \frac{CrOR {1}^{2} + {CrIR}^{2}}{CrOR {1}^{2} - {CrIR}^{2}} + {v}_{Cr 1} ) \qquad Eq . 45$$

$${Cr}_{2} = \frac{CrIR}{{E}_{Cr 2}} \times ( \frac{CrOR {2}^{2} + {CrIR}^{2}}{CrOR {2}^{2} - {CrIR}^{2}} + {v}_{Cr 2} ) \qquad Eq . 46$$

$$Cc = \frac{1}{{E}_{Cc}} \times \frac{CcIR}{CcOR} \times ( CcOR - CcIR ) \qquad Eq . 47$$

Where,

CrOR1 is the outer radius of a first one of the two compression rings 271, in its neutral, un-deformed state.

CrOR2 is the outer radius of a second one of the two compression rings 272, in its neutral, un-deformed state.

E_{Wh} is the Young's modulus of the housing body 212.

E_{Cr1} is the Young's modulus of the first of the two compression rings 271, 272.

E_{Cr1} is the Young's modulus of the second of the two compression rings 217, 272.

HalR is the inner radius of the gripped section of the hanger body 8 in its neutral, un-deformed state.

P_{bore} is the applied fluid pressure at the inner surface of the hanger 8 in the gripping system in its gripped state.

ν_{Cr1} is the Poisson's ratio of the first one of the two compression rings 271, 272.

ν_{Cr2} is the Poisson's ratio of the second one of the two compression rings 271, 272.

ν_{Ha} is the Poisson's ratio of the hanger 8.

ν_{Wh} is the Poisson's ratio of the housing body 212.

### Rated Load Capacity

Once the contact stresses have been calculated, the rated load capacity of the clamping system can be determined. It will be appreciated that the rated load capacity of the clamping system 110, 210, for a given load scenario, must equal or exceed the applied load in that scenario. This means that the clamping system 110, 210 is able to support any combination of loads applied to the clamping system 110, 210 in any expected load scenario.

The rated load capacity of the clamping system 110, 210 is given by:

$$RL = \frac{Q \times Φ \times {A}_{s}}{SF} \qquad Eq . 48$$

Where,
Q is the contact stress at the friction interface,
ϕ is the grip coefficient at the friction interface,
Aₛ is the surface area at the friction interface, and
SF is a safety factor with respect to the minimum load capable of causing slip.

The grip coefficient (Φ) is a ratio of a minimum axial load (Fₛ) capable of causing slip at the friction interface to the radial force (Fₙ) applied to the friction interface 130, 230. The axial load (Fₛ) is applied in a direction generally parallel to the friction interface 130, 230 and the radial force (Fₙ) is applied in a direction generally perpendicular to the friction interface 130, 230.

The grip coefficient may be determined empirically or by experimentation, or may be calculated by any known method. Preferably the grip coefficient is determined experimentally to take into consideration all of the complex factors affecting the grip coefficient in a clamping system 110, 210, such as variability in coefficients of friction over the areas of the gripping surfaces and the effect of a toothed surface biting into a mating surface.

### Safety Factor

The safety factor will vary based on the conditions of the load scenario considered. The safety factor preferably takes in consideration the following factors as a minimum:
The reliability of the clamping system 110, 210 as a whole;
The installation history of the clamping system 110, 210;
The likelihood of the load scenario in question occurring;
The consequences of slip if slip were to occur;
The source of any loadings and whether these loadings could be actively reduced in an emergency situation; and.
The presence of any additional load supporting mechanisms.

The safety factor is preferably between 1.1 and 1.5, and more preferably between 1.2 and 1.4. In particular, the safety factor may be approximately 1.4 for load scenarios in which the applied load is largely uncontrollable (for example due to drilling pressures or production pressures). The safety factor may be approximately 1.2 for load scenarios in which the loading is actively applied (for example test loads) or for load scenarios with reduced load capacities due to temperature differentials, as these are generally actively applied.

### Load Scenarios

It will be appreciated that the contact stresses between components of the clamping system 110, 210 will vary based upon the loads that are applied to wellhead system. These loads result in a number of different load scenarios. The results of the above calculations are, therefore, dependent on the particular load scenario being considered, with each load scenario comprising a different combination of load conditions on the clamping system. Each load scenario preferably includes one or more of the following loads or factors.

Pressurised fluids present at any location within the wellhead system have the potential to affect contact stresses within the clamping system 110, 210. Fluid pressures that may be considered are:
Pressure due to a fluid (production fluid or hydrostatic test fluid) inside a casing or tubing head in a region where a hanger 8 is not yet installed;
Pressure due to a fluid inside a hanger 8 (which may increase the contact stress at the friction interface);
Pressure due to a fluid at the friction interface (which may decrease the contact stress at the interface);
External hydrostatic pressure; and
Any other fluid pressure present at the interfaces between components of the clamping system 110, 210.

The extent of the effect of any pressurized fluids on contact stress may vary based on the size of the area over which the pressure acts within the clamping system 110, 210. In particular, the extent of the effect of any pressurized fluids on contact stress may vary based on the axial length of the area over which the pressure acts. Axial lengths of the pressure-affected regions may vary based on a number of factors, including, but not limited to:
The range of axial locations in which an adjustable hanger may land;
Axial location(s) of seal(s) at interfaces between components of the clamping system 110, 210; and
Failure of seals at interfaces between components of the clamping system 110, 210.

Tensile axial loads and compressive axial loads may be applied to a hanger 8 and/or another wellhead component directly. Alternatively, tensile axial loads and compressive axial loads may be applied to a hanger 8 and/or another wellhead component indirectly, for example through casing, tubing, or other equipment supported inside the component. Preferably the worst-case axial loadings are included in the definition of any load scenario.

External bending moments may be applied to a casing head or a tubing head directly. Alternatively, external bending moments may be applied to a casing head or a tubing head indirectly, for example through the attached casing or tubing. Preferably the worst-case external bending moments are included in the definition of any load scenario.

In some cases, the friction interface must resist rotation. Rotation may be applied to a wellhead system through any rotating component contacting the wellhead component being analysed. If present, worst-case rotational loading may be included in the definition of any load scenario.

Preferably the worst-case effect of temperature on the clamping system 110, 210 is included in the definition of a load scenario. Any state or event that may affect the temperature of the clamping system may be considered. States and events requiring consideration may include:
Environmental ambient temperature at the wellhead system;
Heating or cooling of the wellhead system due to the flow of produced fluids through the wellhead system;
Heating or cooling of the wellhead system due to the flow of fluids pumped down the wellhead system from the surface; and
Cooling due to the expansion of gas vented to the atmosphere through a wellhead outlet or nearby outlet.

Once the thermal state of the system has been identified, the effect it has on the clamping system 110, 210 should be determined. The effects of temperature on the clamping system 110, 210 may include:
Changes in material properties due to extreme temperatures. Accordingly, the effect of extreme temperatures on the properties of the materials used is preferably determined.
Differential expansion of components of the clamping system 110, 210 due to temperature differentials. Components of the clamping system 110, 210 may expand or contract due to temperature. If a temperature differential is present across the clamping system 110, 210, then different components within that clamping system 110, 210 may be at different temperatures. Accordingly, different components within the clamping system 110, 210 may expand or contract to varying and different degrees, depending on the temperature or temperature range present at each component. This may have a direct effect on contact stresses at the interfaces between these components.
Increased pressure at interfaces due to liquid expansion. If liquid is present in a trapped void between two seals at an interface between components of the clamping system 110, 210, then heating may cause the pressure in this region to rise, potentially resulting in a change to the contact stress at the interface in question.

### Factors Affecting Contact Stress

Contact stresses in the clamping system 110, 210 may be dependent upon the stiffness of the outermost components of the clamping system 110, 210, namely the activating spool 118 or the compression rings 218, 271, 272, that compress the inner components of the clamping system 110, 210.

Any features that may reduce the stiffness of the components may be taken into account. These features may include, but are not limited to:
Steps or profiled features on the outer diameter of the component;
Through holes for studs or bolts;
Tapped and threaded holes for studs or bolts; and.
Piston bores for integral hydraulic mechanisms.

Any slots or holes present on or in components of the clamping system 110, 210 may affect how that component will deform under activation of the clamping system 110, 210. This may, in turn, affect the contact stresses developed at the interfaces between the components of the clamping system 110, 210. Two features that may be accounted for are:
The presence of slots or holes on or in a component of the clamping system 110, 210 which decreases the component's hoop stiffness in the affected region; and
Ribs between slots that may be compressed by radial loads applied due to activation of the clamping system 110, 210.

Contact stresses at interfaces between components of the clamping system 110, 210 may be sensitive to small variations in key dimensions at these interfaces. Accordingly, when determining contact stresses for any individual load scenario, the worst-case combination of individual manufacturing tolerances for that load scenario is preferably considered.

One particular factor that may lead to variations in key dimensions at interfaces is the thicknesses of coatings and surface treatments applied to surfaces of the components of the clamping system 110, 210. When determining contact stresses for any individual load scenario, preferably the worst-case combination of coating/surface treatment thicknesses for that load scenario is considered.

Pressure exerted by fluids outside a component of the clamping system 110, 210, inside a component of the clamping system 110, 210, or at the interfaces between components of the clamping system 110, 210 may affect the contact stresses developed due to activation of the clamping system 110, 210. For any load scenarios with fluid pressures present at these interfaces, the effects of these pressures may be included in the determination of the contact stresses.

Temperature gradients across a wellhead system 110, 210 can result in differential expansion or contraction of components, either increasing or decreasing the contact stresses developed at the interfaces between components of the clamping system 110, 210.

The material properties of components of the clamping system 110, 210 play a key role in determining how the parts deform during the gripping process. In particular, the Young's Modulus, Poisson's ratio, material hardness, material yield strength, and ultimate tensile strength of all components must be considered when determining contact stresses for a given load scenario.

Other modifications and variations not explicitly disclosed above may also be contemplated without departing from the scope of the invention as defined in the appended claims.

1. A method of calculating the load capacity of a wellhead system, the wellhead system comprising a clamping arrangement comprising a collar having an externally tapered surface, the arrangement also including an annular component with an internally tapered surface, the collar and the annular component being relatively axially moveable between a first position in which the tapered surface of the annular component exerts no radial force on the collar and a second position in which the tapered surface of the annular component exerts sufficient radial force to distort the collar inwardly in order to grip an inner tubular member within a gripping surface and to support a load of the inner tubular member, the inner tubular member having an outer surface including a ridged profile, and the method comprising:
determining a first contact stress at a first interface between the annular component and the collar, by equating a radial deflection of an inner surface of the annular component with a radial deflection of an outer surface of the collar;
using the first contact stress and the axial movement of the annular component to determine a contact stress at a gripping interface between the gripping surface and the inner tubular member, by equating a radial deflection of the outer surface of the inner tubular member with (i) a radial deflection of the gripping surface plus (ii) a depth of penetration of a ridge of the outer surface of the inner tubular member into the gripping surface (iii) a radial dimension of an initial gap between the outer surface of the inner tubular member and the inner surface of the outer tubular member.

2. A method of calculating the load capacity of a wellhead system according to any preceding claim in which the inner tubular member is arranged to be suspended from the gripping surface and for the inner tubular member to extend downwardly within an outer tubular member.

3. A method of calculating the load capacity of a wellhead system according to claim 1 or claim 2 in which the gripping surface is provided on an inner surface of the collar and the gripping interface is formed between the inner surface of the collar and the outer surface of the inner tubular member.

4. A method of calculating the load capacity of a wellhead system according to claim 1 or claim 2 in which the gripping surface is provided on an inner surface of an outer tubular member, the outer tubular member being located between the outer surface of the inner tubular member and the inner surface of the collar and wherein the gripping interface is formed between the inner surface of the outer tubular member and the outer surface of the inner tubular member.

5. A method of calculating the load capacity of a wellhead system according to claim 4 wherein the method comprises determining a second contact stress at a second interface between the collar and the outer tubular member assuming negligible hoop stiffness of the collar.

6. A method of calculating the load capacity of a wellhead system according to claim 5 wherein the method comprise using the first contact stress, the second contact stress and the axial movement of the annular component to determine a contact stress at the gripping interface between the outer tubular member and the inner tubular member

7. A method of calculating the load capacity of a wellhead system according to any one of claim 4 to claim 6 wherein step (i) comprises equating the radial deflection of the outer surface of the inner tubular member with a radial deflection of an inner surface (the gripping surface) of the outer tubular member.

8. A method of calculating the load capacity of a wellhead system according to any one of claim 4 to claim 7 wherein step (ii) comprises equating the radial deflection of the outer surface of the inner tubular member with the depth of penetration of a ridge of the outer surface of the inner tubular member into the gripping surface comprising an inner surface of the outer tubular member.

9. A method of calculating the load capacity of a wellhead system according to any one of claim 4 to claim 8 wherein step (iii) comprises equating the radial deflection of the outer surface of the inner tubular member with the radial dimension of the initial gap between the outer surface of the inner tubular member and the gripping surface comprising an inner surface of the outer tubular member.

10. A method of calculating the load capacity of a wellhead system according to any preceding claim wherein the method comprises calculating the contact stress at the first interface and subsequently calculating the contact stress at the gripping interface.

11. A method of calculating the load capacity of a wellhead system according to claim 5 or any one of claim 6 to claim 10 when dependent upon claim 5 wherein the method comprises calculating the contact stress at the first interface and the contact stress at the second interface and subsequently calculating the contact stress at the gripping interface.

12. A method of calculating the load capacity of a wellhead system according to claim 10 wherein the method comprises adjusting the contact stresses at the first interface to provide a gripping contact stress which is equal to or greater than a desired contact stress at the gripping interface.

13. A method of calculating the load capacity of a wellhead system according to claim 11 wherein the method comprises adjusting the contact stresses at the first interface and the second interface to provide a gripping contact stress which is equal to or greater than a desired contact stress at the gripping interface.

14. A method of calculating the load capacity of a wellhead system according to claim 12 or claim 13 wherein the method comprises adjusting the desired contact stress based on a given load scenario.

15. A method of calculating the load capacity of a wellhead system according to claim 14 wherein the method comprises adjusting the desired contact stress based on a given load scenario together with a safety factor.

16. A method of calculating the load capacity of a wellhead system according to any preceding claim wherein the rated load capacity of the clamping system is given by:
$$RL = ( Q \times Φ \times A\_s ) / SF$$
where,
Q is the contact stress at the gripping interface,
ϕ is the grip coefficient at the gripping interface,
As is the surface area at the gripping interface, and
SF is a safety factor with respect to the minimum load capable of causing slip between the inner tubular member and the gripping surface.

17. A method of calculating the load capacity of a wellhead system according to claim 16 wherein the method comprises determining the grip coefficient (ϕ) as a ratio of a minimum axial load (Fs) capable of causing slip at the gripping interface to a radial force (Fn) applied to the gripping interface.

18. A method of calculating the load capacity of a wellhead system according to claim 17 wherein the axial load (Fs) is applied in a direction generally parallel to the gripping interface and the radial force (Fn) is applied in a direction generally perpendicular to the gripping interface.

19. A method of calculating the load capacity of a wellhead system according to any one of claim 16 to claim 18 wherein the grip coefficient is determined experimentally to take into consideration complex factors affecting the grip coefficient in a clamping system including variability in coefficients of friction over the areas of the gripping surfaces and the effect of a toothed surface biting into a mating surface.

20. A method of calculating the load capacity of a wellhead system according to any preceding claim wherein the method comprises manufacturing a wellhead.

21. A method of calculating the load capacity of a wellhead system according to any preceding claim wherein the method comprises manufacturing the collar and the annular component.

22. A method of calculating the load capacity of a wellhead system according to claim 16 wherein the method comprises selecting a material and dimensions for the collar and selecting a material and dimensions for the annular component in order to achieve the rated load capacity and manufacturing the collar and the annular component using these selected dimensions and materials.

23. A method of calculating the load capacity of a wellhead system, the wellhead system comprising a clamping arrangement comprising a collar having an externally tapered surface, the arrangement also including an annular component with an internally tapered surface, the collar and the annular component being relatively axially moveable between a first position in which the tapered surface of the annular component exerts no radial force on the collar and a second position in which the tapered surface of the annular component exerts sufficient radial force to distort the collar inwardly in order to grip an inner tubular member within an outer tubular member to support a load of the inner tubular member, the inner tubular member having an outer surface including a ridged profile, and the method comprising:
determining a first contact stress at a first interface between the annular component and the collar, by equating a radial deflection of an inner surface of the annular component with a radial deflection of an outer surface of the collar;
determining a second contact stress at a second interface between the collar and the outer tubular member assuming negligible hoop stiffness of the collar; and
using the first contact stress, the second contact stress and the axial movement of the annular component to determine a contact stress at a third interface between the outer tubular member and the inner tubular member, by equating a radial deflection of the outer surface of the inner tubular member with (i) a radial deflection of an inner surface of the outer tubular member plus (ii) a depth of penetration of a ridge of the outer surface of the inner tubular member into an inner surface of the outer tubular member plus (iii) a radial dimension of an initial gap between the outer surface of the inner tubular member and the inner surface of the outer tubular member.

24. A method of constructing a wellhead comprising:
calculating a load requirement of the wellhead;
calculating the load capacity of a wellhead system in accordance with any preceding claim;
constructing the wellhead by selecting a combination of a clamping arrangement and inner tubular member to provide said load capacity for the wellhead.

25. A method of constructing a wellhead according to claim 25 further comprising selecting a material and dimensions for:
the collar;
the annular component;
the inner tubular member; and
the gripping surface.
